(19) United States
(12) Patent Application Publication
(10) Pub. No.: US 2024/0310866 A1
(43) Pub. Date: Sep. 19, 2024

(54) PCSELS FOR OPTICAL NEURAL NETWORKS/PHOTONIC COMPUTING/NEUROMORPHIC COMPUTING

(71) Applicant: Seagate Technology LLC, Fremont, CA (US)

(72) Inventors: Vivek Krishnamurthy, Edina, MN (US); Aditya Jain, Minneapolis, MN (US); Richard Charles Alexander Pitwon, Wexford (IE); Anil J. Reddy, Minneapolis, MN (US)

(21) Appl. No.: 18/603,512

(22) Filed: Mar. 13, 2024

Related U.S. Application Data
(60) Provisional application No. 63/452,767, filed on Mar. 17, 2023.

(51) Int. Cl. G06E 3/00; G02B 1/00

(52) U.S. Cl. CPC G06E 3/00; G02B 1/005

(57) ABSTRACT

A laser-based computing system includes a two-dimensional photonic crystal surface emitting laser (PCSEL) array including a plurality of PCSEL emitters located in a first layer, each emitter oriented in a direction perpendicular to a plane formed by the first layer, where the plurality of PCSEL emitters form a preset pattern within the first layer, and a controller operatively connected to the plurality of PCSEL emitters, the controller configured to modulate phase and/or amplitude of a beam emitted by a PCSEL emitter of the plurality of PCSEL emitters.

### CROSS-REFERENCE TO RELATED APPLICATIONS

This application claims the benefit of U.S. Provisional Patent Application having Ser. No. 63/452,767 titled “PCSELS FOR OPTICAL NEURAL NETWORKS/PHOTONIC COMPUTING/NEUROMORPHIC COMPUTING” filed Mar. 17, 2023, the entire contents of which are incorporated herein by reference for all purposes herein.

### SUMMARY

In general, this case is directed to utilizing photonic crystal surface emitting lasers (PCSELs) for optical neural networks, photonic computing, or neuromorphic computing applications.

According to a first aspect of the present disclosure, a laser-based computing system is disclosed. According to the first aspect, the system includes a two-dimensional photonic crystal surface emitting laser (PCSEL) array including a plurality of PCSEL emitters located in a first layer, each emitter oriented in a direction perpendicular to a plane formed by the first layer, where the plurality of PCSEL emitters form a preset pattern within the first layer. The system of the second embodiment also includes a controller operatively connected to the plurality of PCSEL emitters, the controller configured to modulate phase and/or amplitude of a beam emitted by a PCSEL emitter of the plurality of PCSEL emitters.

According to a second aspect of the present disclosure, another laser-based computing system is disclosed. According to the second aspect, the system includes a two-dimensional photonic crystal surface emitting laser (PCSEL) array including a plurality of PCSEL emitters located in a first layer, each emitter oriented in a direction perpendicular to a plane formed by the first layer, where the plurality of PCSEL emitters form a preset pattern within the first layer. The system of the second embodiment further includes a photodetector array located in a second layer comprised above the first layer. The system of the second embodiment also includes a controller operatively connected to the plurality of PCSEL emitters and the photodetector array, the controller configured to modulate a plurality of beams emitted by the plurality of PCSEL emitters.

According to a third aspect of the present disclosure, a computer program product for performing optical neural network computations is disclosed, the computer program product including a computer-readable storage medium having program code embodied therewith, the program code comprising computer-readable program code configured to cause a processor to perform steps. According to the third embodiment, the steps to be performed include emitting a beam from a photonic crystal surface emitting laser (PCSEL) array. The steps also include modulating phase and/or amplitude of the emitted beam. The steps also include receiving a communication from a photodetector based on the emitted beam. The steps also include performing a linear or non-linear beam control operation based at least in part on the communication received from the photodetector.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIGS. 1A and 1B show cross-section views of components of an example photonic crystal surface emitting laser (PCSEL) system, according to various embodiments.

FIG. 2 shows a photonic crystal for use with a PCSEL, according to various embodiments.

FIG. 3 shows an example photonic bandgap for a PCSEL, according to various embodiments.

FIGS. 4 graphically shows relative transmission and reflection efficiencies corresponding to photonic crystals, according to various embodiments.

FIG. 5 shows an example of an optical neural network with multiple hidden layers, according to various embodiments.

FIG. 6 is a top view of photonic crystal components of a PCSEL-based system, according to various embodiment.

FIG. 7 is a top view of the photonic crystal components of the PCSEL-based system of FIG. 6, further showing a dielectric layer positioned on the photonic crystal layer, according to various embodiments.

FIG. 8 is a cross-sectional side view of the components of FIG. 7, according to various embodiments.

FIG. 9 is a top view of the photonic crystal components of the PCSEL-based system of FIGS. 7 and 8, further showing a photodetector sensor layer positioned over the coupler, and various signal reading and summation components, according to various embodiments.

FIG. 10 is a cross-sectional side view of the components of FIG. 9, according to various embodiments.

FIG. 11 shows an example of non-linear control at various example activation weights, according to various embodiments.

FIG. 12 shows an example of linear control at various example operation weights, according to various embodiments

FIG. 13 is an example layered photonic crystal surface emitting laser system utilizing current summation, according to various embodiments.

FIG. 14 is an example of PCSEL system operation, according to various embodiments.

FIG. 15 shows a process, according to various embodiments.

FIG. 16 is a block schematic diagram of a computer system according to embodiments of the present disclosure.

### DETAILED DESCRIPTION

The methods, systems, and features described herein provide for utilizing semiconductor lasers including photonic crystal surface-emitting lasers (PCSELs), and include embodiments applicable to artificial neural networks (ANNs), such as optical neural networks (ONNs), and more particularly to employing PCSELs in the ONN context to improve ONN performance with benefits including improved energy efficiency, cost effectiveness, parallelization, high speed, among other benefits.

Existing and experimental laser-based systems, including semiconductor-based laser systems, have been shown to be applicable to a wide range of applications. One application of semiconductor-based laser systems is photonic computing, including optical neural networks, photonic computing, or neuromorphic computing. Each of these applications have been increasingly promising in certain cases using silicon photonics, existing vertical cavity surface-emitting lasers (VCSELs), etc., in computing environments. Related practical challenges remain, such as computational scalability and energy efficiency. In silicon photonics or Lithium Niobate or AlGaAs-based photonic chips, a number of channels scales with each layer of switches and hence poses a limitation on scaling, for a given chip real estate. Also, poor electron-photon and photon-photon interaction significantly increases the energy required for non-linear activation, and hence the amount of energy required per operation.

VCSEL arrays have been shown to address energy efficiency limitations by controlling the interference of beams via phase modulation to achieve non-linear activation. VCSELs have nevertheless been hindered by large footprints, which have limited the number of operations in a given area per second (computational density). Wavelength coherence, when a VCSEL array is used for non-linear activation, requires external laser to pump electrically biased-VCSEL array, increasing the energy requirements. Utilizing the external laser for coherent locking of lasers, also limits the scalability of the technology.

The present disclosure provides a significant breakthrough in laser and computing architectures and technologies by utilizing photonic crystal surface-emitting lasers (PCSELs) in place of existing VCSELs. PCSELs, as described herein, have been shown to simplify and to improve both scalability and efficiency limitations compared to VCSELs. Embodiments have the benefit of smaller emitters (10-100X smaller vs. VCSEL emitters, which can be 10-100 microns [um] wide), and also benefit from inherent, coherent laser beam locking, due to laterally-confined lasing modes. Smaller emitters can be enabled through smaller active areas of PCSELs, as described further, below. Thus, PCSELs avoid a need for an external laser for coherent injection locking as was required in VCSELs. The smaller PCSEL size, together with non-requirement of an external laser, enables significantly higher computational density and energy efficiency when using PCSELs in computing environments, such as ONNs. PCSEL arrays are much smaller than VCSEL arrays and are inherently coherent, enabling scalability and energy efficiency. Also contemplated are optically-phased arrays of PCSELs. PCSELs structurally can operate with a larger active area while maintaining a capacity for single-mode operation. PCSELs can be configured to use a constant or pulsed beam, in various cases. In fact, PCSELs can utilize high modulation frequencies, benefiting computational speeds.

In general, and according to various embodiments of the photonic crystal and PCSELs contemplated herein, PCSELs allow for a smaller separation of laser emitters, thus more laser channels/input ports, and thus facilitate parallel and massively parallel operations. With PCSELs, numerous drawbacks and restrictions of VCSELs are overcome, such as the known issue of multi-super-mode excitation, which is avoided entirely. Other improvements that PCSELs offer over VCSELs includes improved laser control aspects. For example, not only interference of a diffracted beams, but also coupling control between various emitters can be additional parameters for setting weights. Furthermore, no external laser is required for PCSELs. Thus, beam and optical collimation structures are simplified or removed entirely due to the inherent nature of PCSELs laser beam coherency. Electro-optic (EO) conversion efficiency is also an advantage in PCSELs when compared to VCSELs due in part to the size of the emitter and in-plane confinement of modes.

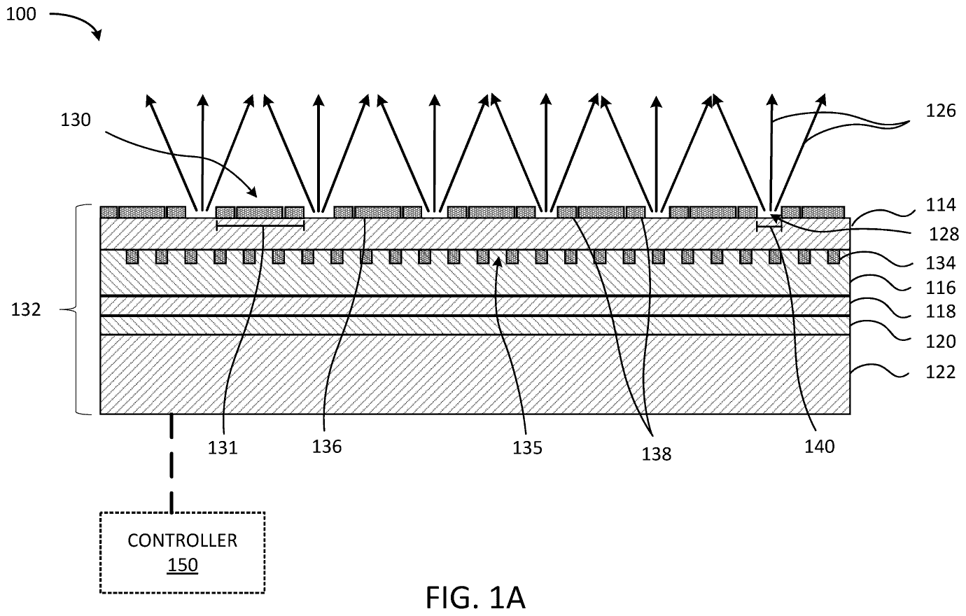

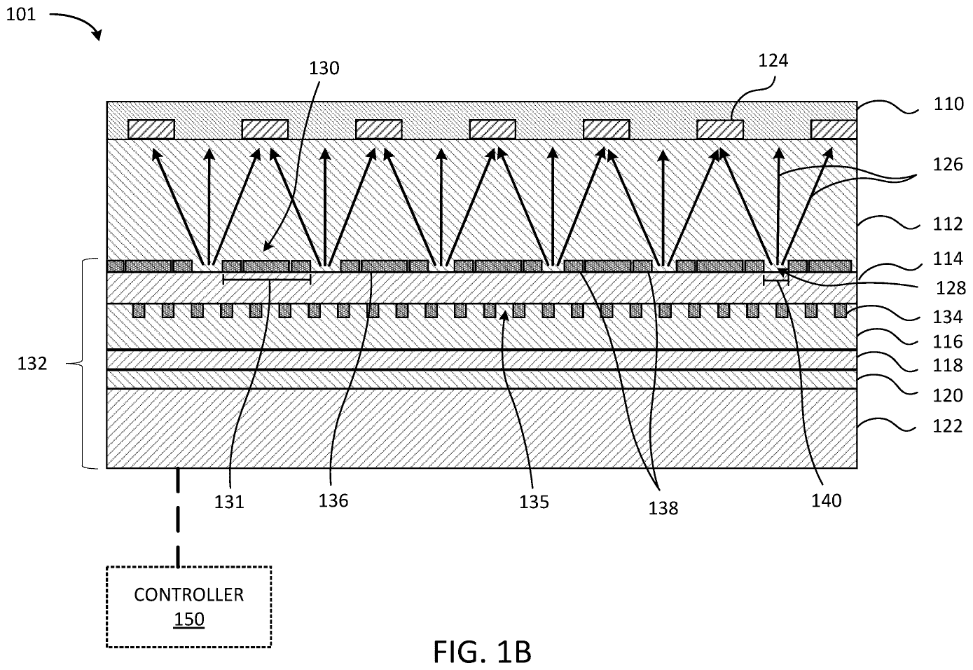

Turning now to FIGS. 1A and 1B, FIG. 1A shows a cross section view of a system 100 including components 132 of an example photonic crystal surface emitting laser (PCSEL) device operatively connected to a controller 150. As contemplated herein, the example PCSEL system 100 includes an array of emitters, in which optical emission of coherent beams can be electronically controlled. The example PCSEL system 100, as shown, improves on a number of aspects and limitations of the previous, vertical cavity surface-emitting lasers (VCSELs). PCSELs represent a significant technological breakthrough in semiconductor lasers, and have many and diverse useful applications, according to various embodiments, herein. System 101 of FIG. 1B adds additional detection features to system 100 of FIG. 1A. Throughout the following description it is understood that various embodiments can use systems 100 and 101 interchangeably where applicable.

As shown, the PCSEL system 100 includes a multi-layered, stacked structure in which multiple horizontal layers are stacked vertically, and which are configured to vertically and outwardly emit surface laser beam(s) 126 from an end, such as an upper end (e.g., of system 101). As shown in FIG. 1B, the upper end of the system 101 can include a photodetector (PD) array layer 110 as shown in the embodiment of system 101. The PD array layer 110 can be external or integrated according to various embodiments. As shown one or more sensors or detectors at PDs 124 can be associated with the layer 110.

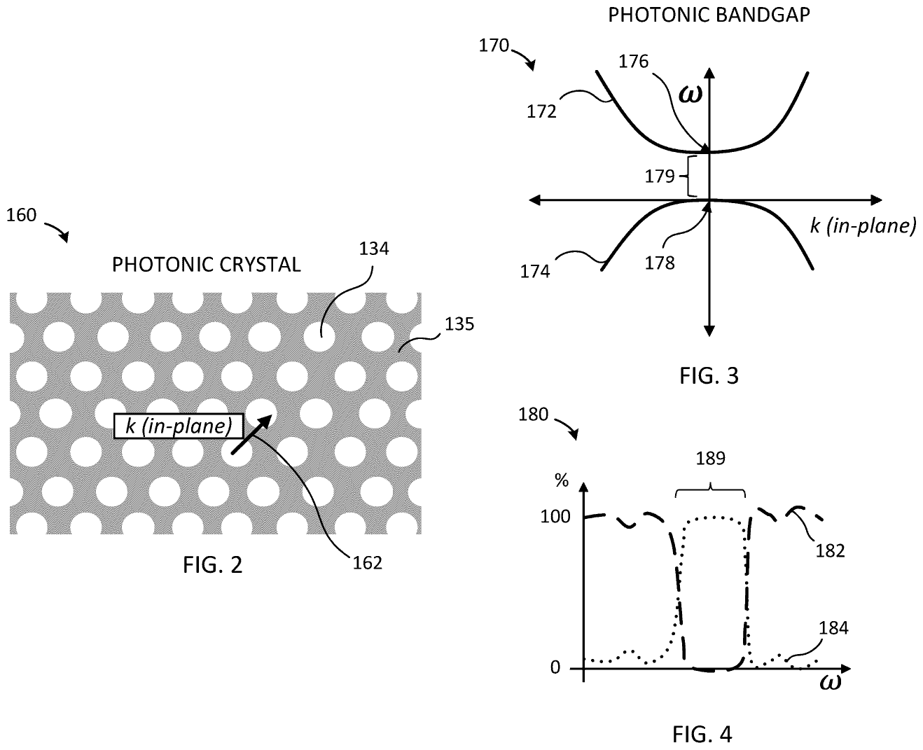

Still referring to FIG. 2B, below PD array layer 110 is a dielectric layer 112. The dielectric layer 112 can be deposited in various embodiments. In other embodiments, the dielectric layer 112 can be open space or air. The dielectric layer 112 can be between 100 nm and 100 um in height/thickness in various embodiments.

At the base of and below the dielectric layer 112 as shown, is a sub-portion of the system stack including a number of PCSEL components 132 as described and shown in FIG. 1A. At an upper portion of the PCSEL layer 132 are electrical contacts for controlling coupling between emitters in gaps at 136 and electrical contacts for controlling laser emission at contacts 138. Electric contacts 136 and 138 can be coplanar, as shown. An overall contact width of groups 131 of two contacts 138 and one contact 136 as shown can have a contact width 130 of approximately 1-100 um. As shown, between adjacent groups 130 can be an open gap (128) between contacts 138 of a gap width of approximately 0.1-10 microns (um). As described herein, laser emissions of laser beam(s) 126 can enter the dielectric layer 112 through gap(s) (at 128), which as described in greater detail below, are representative of PCSEL emitters 128.

The PCSEL components 132 also include a p-doped layer 114. The p-doped layer 114 can be about 1-2 um in height/thickness in various embodiments. Located below the p-doped layer 114 (e.g., AlGaAs) as shown is a p-doped separately confined heterostructure (SCH) layer 116 (e.g., InGaP). The p-doped SCH layer 116 can be about 50 nm to 1 um in height/thickness in various embodiments.

As shown, layer 116 can comprise photonic crystals (in two-dimensional lattice, see also 160 of FIG. 2) comprising relatively low refractive index material (or holes) 134 with corresponding gaps 135 located therebetween. The low refractive index material lattice of holes 134 can either be partially or fully etched through p-SCH layer 116. In various embodiments, the photonic crystal holes 134 cause the excitation of band-edge modes (see also FIG. 3) in the active layer 118. The low refractive index holes 134 can form a regular grid or pattern, and may or may not include one or more lattice irregularities also called “defects,” briefly discussed further below.

Located below the active p-doped SCH layer 116 in the stack of PCSEL components 132 of system 101 is a layer of multiple quantum wells/quantum dots (active elements) at 118. The layer 118 can be about 50 nm to 150 nm in height/thickness in various embodiments. Located below layer 118 is an n-doped SCH layer at 120 (e.g., AlGaAs). The n-doped SCH layer 120 can be about 50 nm to 1 um in height/thickness in various embodiments. Finally, at the base of PCSEL components 132 of system 101, as shown, is an n-doped substrate 122. The substrate 122 can be any suitable height/thickness in various embodiments. The layer arrangement and configuration presented in system 101 is to be viewed as an example, and other variations and modifications are also contemplated herein. For example, according to practical needs, number of n-doped, p-doped and/or active layers could be increased or decreased among other variations.

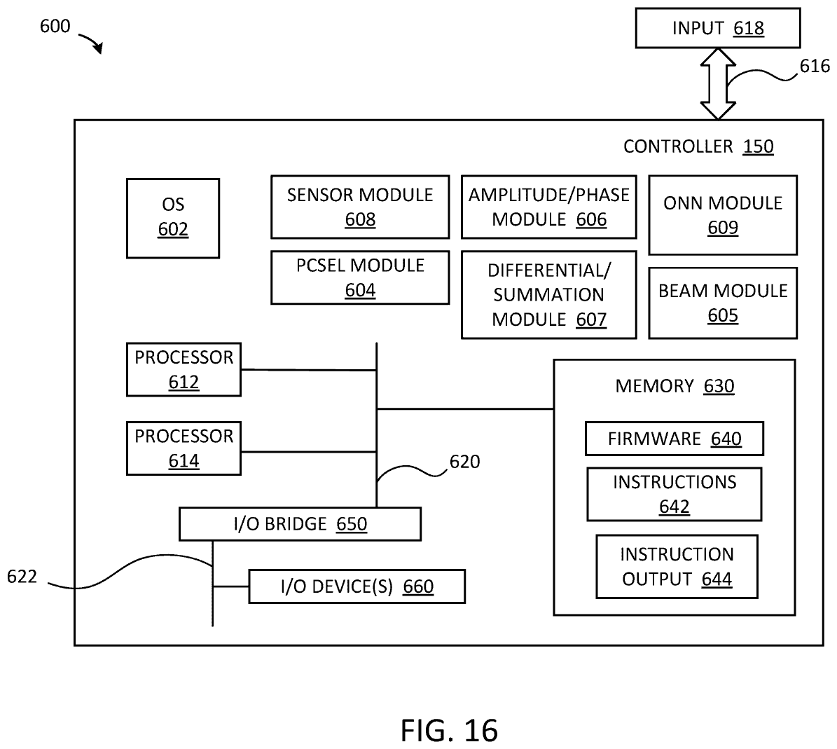

Operatively connected to the system 101 is an optional controller 150, an embodiment of which is described in greater detail in FIG. 16, below. The controller 150 optionally includes a bias (e.g., electrical) source or driver. The controller 150, as shown, can be operatively connected to the various components of system 101.

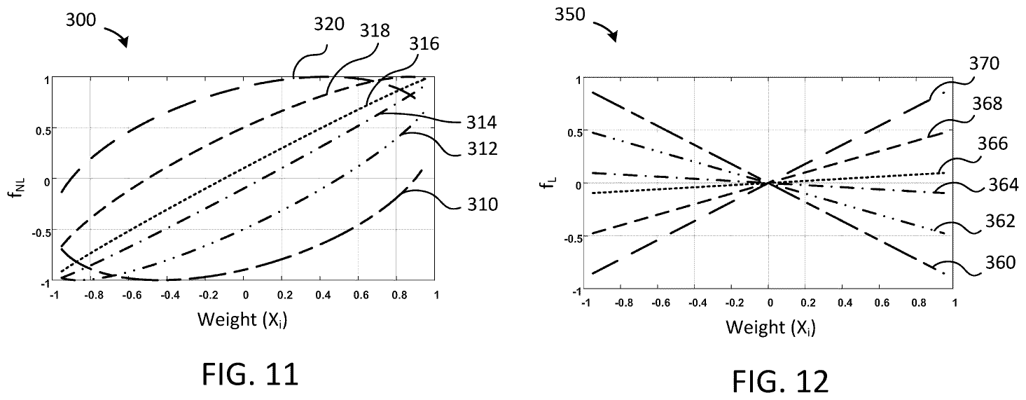

As used herein, the controller 150 can be configured to control the coupling electrodes 136 for beam steering and/or to control beam phase and to control emission electrodes 138, such as for non-linear activation (see also FIG. 11), and for linear operation (see also FIG. 12). For example, the controller 150 can be configured to control PCSEL emission and beam(s) 126, including but not limited to modulating beam phase and amplitude to provide for controlling beam steering angle and intensity, respectively. By using the controller 150 to control beam steering angle and/or intensities, interference of beams between adjacent PCSEL emitters 128 and/or arrays thereof can also be controlled, which in turn allows for achieving various operations.

For example, the controller 150, by controlling angle and/or intensities of one or more beams 126 or beam components, can achieve linear operation and non-linear activation for neuromorphic computation/optical neural networks (ONNs), which can be detected as the summation of differential signals in a PD array layer 110 of FIG. 1B. As shown, the PD array layer 110 can comprise one or more PDs 124 (optionally corresponding to a number of PCSEL emitters 128), and the PDs 124 can also be operatively connected to controller 150.

The example photonic crystal lattice at layer 116, including lower refractive index areas 134 and higher refractive index areas 135 can take various shapes, arrangements, forms. One example arrangement of a photonic crystal layer 160 of FIG. 2, which shows a regular, two-dimensional, hexagonal lattice arrangement of lower refractive index holes 134 in the higher refractive index (and higher optical intensity) layer 135 of general photonic crystal layer 116 of the PCSEL structure of system 101. Also shown in a k (in-plane) wavevector 162 corresponding to a resulting emission. Layer 160 can represent a subset of layer 116, as described herein. In various other arrangements, some of the holes 134 could be removed/omitted to form “defects” in the lattice of layer 160. These defects, if present in higher refractive areas 135, can also be emission regions associated with emitters 128.

Known Bragg-type or other reflection and transmission is contemplated in various components and embodiments, herein. In various embodiments, the lattice arrangement in layer 116 of photonic crystal lattice 160 formed by 134/135 is configured such that at least a mode has a distinctly lowest threshold pump power. In various embodiments, laser emission at emitters 128 can be controlled (e.g., using controller 150) using current injection. Furthermore, coupling between the emitters 128 can be controlled (e.g., beam steering) by controlling a loss (current injection) between emitters 128.

An example PCSEL photonic bandgap 179 is provided at graph 170 of FIG. 3. As shown, two bands 172 and 174 have band edges at relative minima 176 and maxima 178, respectively at a closest point between band edges, shown separated by bandgap 179. The two axes shown include k (in-plane) on the x-axis, and ω (angular frequency of light) on the y-axis. As used herein, k (in-plane) denotes a reciprocal of spatial periodicity of optical fields, or how many beats of periods are there in a unit distance along the plane.

Turning now to FIG. 4, graph 180 shows an example of corresponding photonic transmission 182 and reflection 184 percentages (efficiencies) 0-100%, at various angular frequencies w and a corresponding band gap 189. Bandgap frequencies correspond to the region where in-plane reflection 184 is high and in-plane transmission 182 is low. Hence, with electrical pumping of optical region, in-plane photonic crystal modes in 134/135 are created and confined that are in-turn emitted through emitter 128. Since the mode is created by the photonic crystal the wavelength and phase are coherent. Hence the emission at all the emitters 128 is coherent. The above thus illustrates an operational principle of PCSELs.

As illustrated in FIGS. 3 and 4, various optical field distributions in photonic crystal lattices (e.g., 160) and resulting band structures are also contemplated. Wavevectors (k-in-plane 162, see FIG. 2) can be compared to frequency (e.g., using formula ωa/2πc) to examine the photonic band gap and associated features and aspects. In some examples, no transverse electric (TE) modes may exist in the photonic band gaps shown at 179/189.

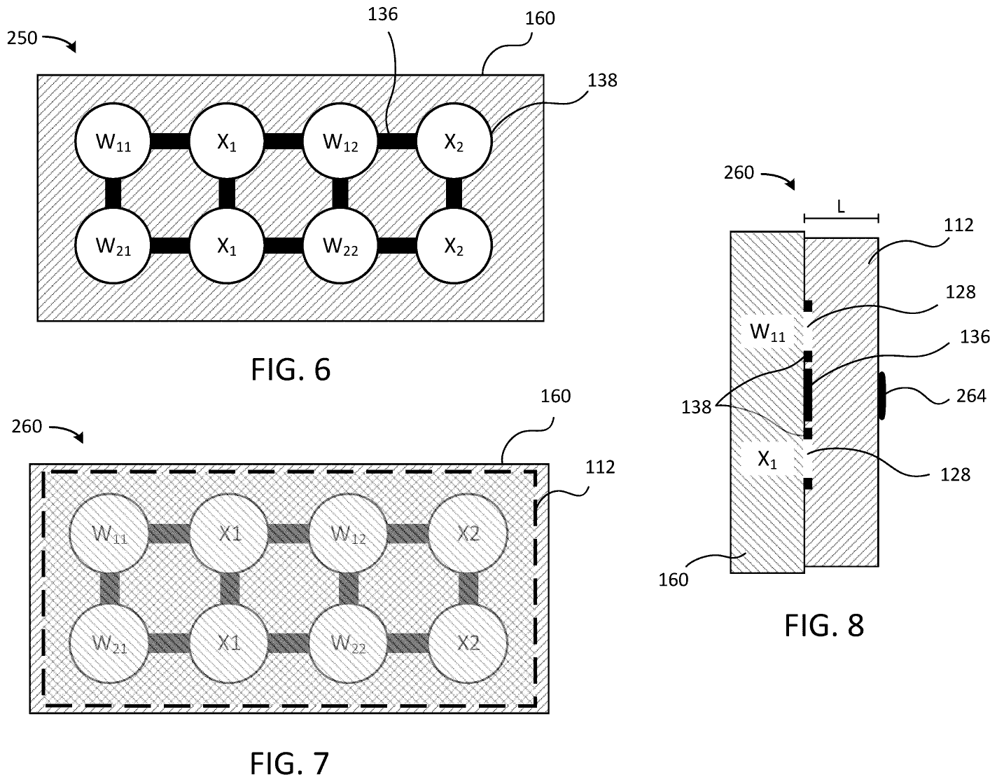

Examples of optical modes, as noted in “Electronic control of coherence in a two-dimensional array of photonic crystal surface emitting lasers” to Taylor et al., include a first-order TE mode, and a fundamental TE mode, although other modes are also contemplated herein. As contemplated herein, and by embedding photonic crystals 134/135 in a PCSEL device, the fundamental TE mode can be excited, by ensuring that they have the highest gain in the laser media. The resulting TE mode would be single mode, single frequency, or single wavelength. Modes contemplated are not only single mode and single frequency or single wavelength as they can be generated simultaneously over the entire crystal 160 comprising 134/135. Various modes can be coherent (same phase) as well, as discussed in Taylor. By having electronic control over the laser, coupling control between the emitters 128 including the angle of a coherent beam, and control of the emission from each emitter 128 (collectively or individually) is achieved. See also FIG. 6, showing electronic coupling control and electronic emission control using PCSELs, as contemplated herein.

With the above structure and understanding of PCSELs, we turn now to employing PCSELs in various deep neural networks (DNNs) and artificial neural networks (ANNs), and more specifically to optical neural networks (ONNs), as described in further detail below.

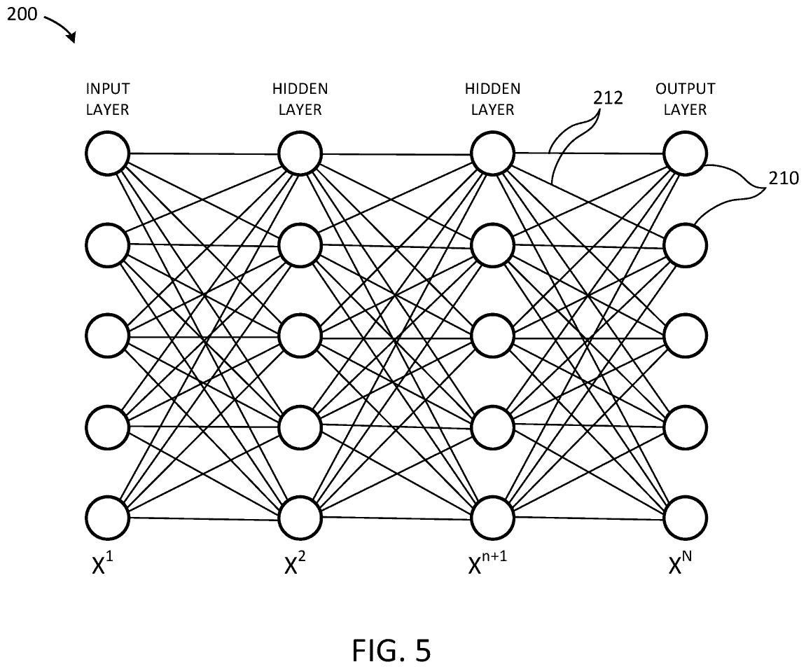

FIG. 5 shows an example of an N-layer ANN at 200, including an input layer X¹, an output layer X^{N}, and multiple hidden layers X², Xⁿ⁺¹, etc. Although four layers are shown (and thus N=4, as shown), each with five nodes 210 therein, any number of layers and/or nodes 210 are contemplated, including layers with varying node 210 count, and varying edge connections 212, which can connect all nodes 210 of a layer to an adjacent layer, or any number of connections less than all, according to various embodiments. Contemplated herein are ONNs that utilize optical communication to perform ANN connections, operations, computations, and the like. As discussed in “Deep Learning with Coherent VCSEL Neural Networks” by Chen, Zaijun et al. (2022), which is hereby incorporated by reference for all purposes, herein, each neural network layer can be configured to compute matrix-vector multiplication followed by a non-linear activation function. Chen provides details of DNN/ONN/ANN operation, which can be adapted as described herein to utilize PCSELs in place of VCSELs. As discussed in Chen, semiconductor lasers such as VCSELs can be employed for computing applications, including ONNs. In various embodiments, DNN, ONN, and ANN are used interchangeably herein where applicable. The present disclosure builds on these concepts using PCSELs and other improvements to related systems.

As further discussed in Chen, homodyne detection of multiple phase-encoding laser fields can result in a non-linear response, and the strength of the non-linearity increases at higher weights, similar to biological neural systems. The present application builds upon the non-linear laser encoding for ONNs by improving upon VCSEL technology with smaller, higher performance, and more efficient PCSELs. The ANN 200, as shown, is one example of many variations of a computing system utilizing PCSELS, as contemplated herein.

FIG. 6 is an example electronic weight and input vector control layer and structure 250 for a PCSEL device including a photonic crystal with a grid of electronically-controllable PCSEL emitters 128 (not called out). Structure 250 for the PCSEL device, including photonic crystal lattice 160 (comprising 134/135, not shown), is shown, over which a corresponding array of emission control units 138 are provided. Emission control units 138 and then connected by a number of coupling control units 136, also referred to as couplers, herein, which connect the emission control units 138 by a grid of such electronically-controllable couplers 136. In particular, emission control units W₁₁, W₁₂, W₂₁, and W₂₂, which represent a weight matrix for neural networks are shown, as well as other additional emission control units 138 denoted X₁ and X₂, which represent input vectors in a neural network. The structure 250 can be located above a photonic crystal layer similar to that shown in FIG. 2, above.

PCSEL emission control (e.g., using controller 150) can be done at various emission sites (corresponding to emitters 128) to control weights Wᵢ (e.g., W₁₁, W₂₁, etc.) and input vectors Xᵢ (e.g., X₁, X₂, etc.). Coupling control (using couplers 136 through controller 150) can occur between emissions sites (e.g., emitters 128). The controller 150 can be used to control coupling at couplers 136 between weights W and vectors X as well as emission amplitudes through emission control units 138, as discussed herein.

FIGS. 7 and 8 show top and side views, respectively, of a PCSEL structure 260 incorporating the features of the photonic crystal control layer 250 of FIG. 6, with the addition of a dielectric layer 112 (can be similar to FIG. 1) positioned above the emission control units 138 and couplers 136 of PCSEL layer 132 (see FIG. 1). The dielectric layer 112 (with a thickness L, see FIG. 8) can facilitate interference of laser beams 126, such as at an interfered spot 264 (of which constructively interfered intensity is represented as I+ and destructively interfered intensity is represented as I−) which as shown can be proximate the dielectric layer 112, as discussed herein. In various embodiments the dielectric layer 112 can be any functional dielectric, including a dielectric material or optionally open space or air. Various operative contacts (e.g., for emission 138, couplers 136, etc.) can be exposed, e.g., for electrical probing.

Couplers 136 can be located at or within the dielectric layer 112 to facilitate interference detection and reading (between weight and input channels, etc.), and can be operatively connected to PCSEL emitters 128 within the photonic layer 120, e.g., corresponding to emission control units 138 (e.g., W₁₁) and another (e.g., X₁) shown in a second column. Using the controller 150 to apply a current to the coupler 136, a linked set of emitted PCSEL laser beams or even an optically-phased array of such beams can produce a desired and detectable beam output and result, e.g., at an interfered spot 264. The dielectric layer 112 can include a filter, splitter, and/or interferometer in various embodiments or can be just a dielectric (buffer) layer 112 (or open space [air]) with the coupler 136 and emitter 138 features only.

The cross-sectional side view of structure 260 at FIG. 8 shows various PCSEL layers, including electronic coupling 136 and/or emission control at 138, a dielectric layer 112, and the interfered spot 264. The example interfered spot 264 is shown at/near a surface of the dielectric layer 112. The side view at FIG. 8 also illustrates how weight and input channel interference can be facilitated by optimizing or defining a (physical or effective) thickness L of the dielectric layer 112 to generate the interfered spot 264 to be utilized for various ONN embodiments described herein.

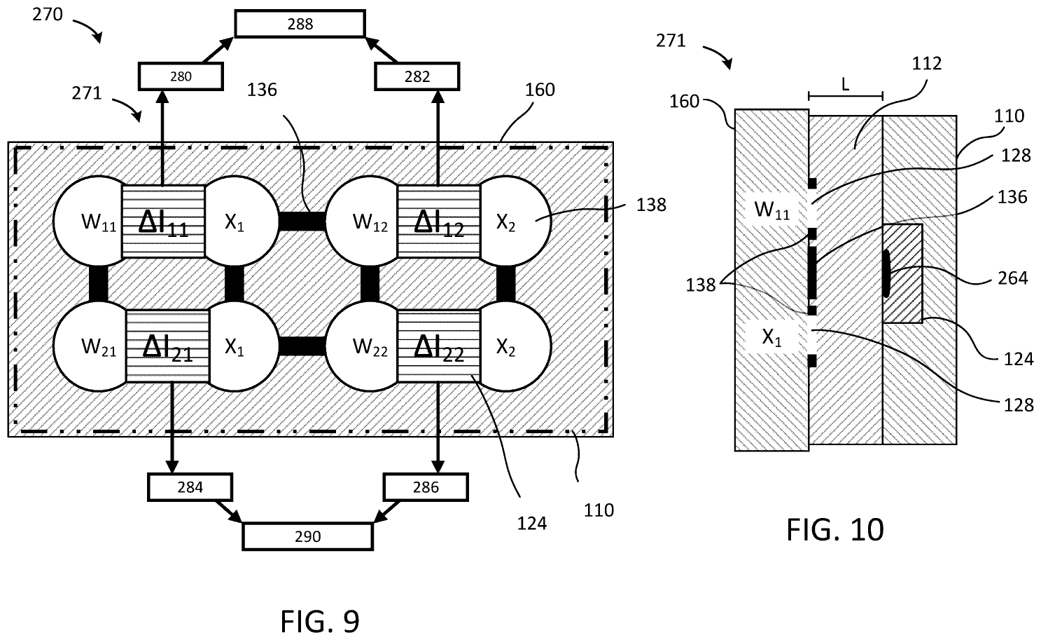

FIG. 9 is a system 270 comprising a structure 271 similar to structure 260, and provided PD array layer 110 (see also FIG. 1) on top of the dielectric 112 described above. With reference to FIG. 9, the dielectric layer 112 is omitted for clarity although it should be understood that dielectric layer 112 is contemplated in various embodiments. System 270 shown at FIG. 9 further includes operative components of a system in accordance with various PCSEL-based ONN and computing system, as discussed herein. The PD sensor layer 110 preferably includes one or more PDs or sensors 124. Shown from a side view at FIG. 10, the PD sensor layer 110 and PD sensor 124 are located above (further to the right, as shown) the dielectric buffer layer 112. Also as shown the interfered spot 264 can optionally be formed on or at the PD sensor 124.

As shown, operative connections (e.g., electrical or otherwise) of system 271 connect various PDs 124 [Δ₁₁, corresponding to the differential current proportional to the difference in intensities of constructively (I+) and destructively (I−) interfered spots created by W₁₁ and X₁, etc. This can be achieved through homodyne detection as discussed by Chen, Zaijun et al. (2022)] to various components of system 270. Each PD sensor 124 has a differential current reading, as shown a reading at 280 for ΔI₁₁, corresponding to W₁₁ and X₁, at 282 for ΔI₁₂, corresponding to W₁₂ and X₂, at 284 for ΔI₂₁, corresponding to W₂₁ and X₁, and at 286 for ΔI₂₂, corresponding to W₂₂ and X₂. Differential current measured by PD can be 124 a measure of interference between weight in input vectors.

The various PDs 124 (e.g., using controller 150) can be configured to perform a read of differential current at 280 and 282, as a first differential current pair, and at 284 and 286, as a second differential current pair.

Also as shown at FIG. 9, the differential current readings at 280 and 282 can be fed in pairs and summed electronically at current-summation module 288, such as by formula: Y₁=W₁₁*X₁+W₁₂*X₂, where Y₁ is a first summed current. and the differential current readings at 284 and 286 are summed electronically at current-summation module 290, such as by formula: Y₂=W₂₁*X₁+W₂₂*X₂, where Y₂ is a second summed current. Based on summed current at Y₁ and Y₂, an ONN can make a computing threshold or other determination based on the detected summed current and laser beam received from the PCSELs, etc.

With reference now to FIG. 10, shown is a side view showing how PD array reads the interfered spot 264 (e.g., I+and I−) to take a difference and generate differential current. Shown are photonic crystal layer 160, electronic coupling control 136, electronic emission control 138, dielectric layer 112, a PD 264 in a PD layer 110, and an interfered spot 264. Currents I+and I− are detected by the PD 264 to generate differential current. Note that various current readings can depend on amplitudes and phase of W and X vectors relating to emission control at 138. By electronically controlling the angle of emission via coupling control of non-linear activation and linear operation can be achieved depending on the weight (phase modulation). By electronically controlling the emission via emission control, linear operation can be achieved (amplitude modulation). See below for additional detail.

In various embodiments, differential optical intensity that is proportional to differential current determination performed by controller at 280, 282, 284, and 286 can use the following formula: to determine differential optical intensity at time t, ΔI(t):

ΔI(t)=I⁺(t)∝AₓA_{w} sin[ϕ_{w}−ϕₓ],

where Aₓ and A_{w} of input vector and weights, respectively; ϕx and ϕw are phases of input vector and weights, respectively.

The following interference equations denote amplitudes of emission beams as Aₓ and A_{w}. Thus, the controller can a pair of PCSELs corresponding to emission control 138 at various PCSELs emitters 128 (e.g., W₁₁ AND X₁) to apply a current bias to the various PCSEL emitters 128 according to the following formulas showing proportionality of optical intensities of constructively and destructively interfered signals, I+ and I−.

$$\begin{matrix}{I}^{+} ∝ {\vert {A}_{X} \vert}^{2} + {\vert {A}_{W} \vert}^{2} + 2 {A}_{X} {A}_{W} sin [ {ϕ}_{W} - {ϕ}_{X} ] , \\ {I}^{-} ∝ {\vert {A}_{X} \vert}^{2} + {\vert {A}_{W} \vert}^{2} - 2 {A}_{X} {A}_{W} sin [ {ϕ}_{W} - {ϕ}_{X} ] ,\end{matrix}$$

As contemplated herein, non-linear activation and linear operation of PCSELs, e.g., in arrays, are contemplated.

FIG. 11 shows an example non-linear function (f_{NL}) graph 300 of a correspondence input vector (Xᵢ), for different example weights (Wᵢ) 310 (−0.9), 312 (−0.5), 314 (−0.1), 316 (0.1), 318 (0.5), and 320 (0.9). As shown a curvature of the resulting correspondence is non-linear.

As shown at FIG. 11, at 314, when weight (Wᵢ) is 0, the shown function is linear with respect to X. Thus, linear operation would be achieved at weight 0. As the weight is changed, the non-linerarity of the function is altered for non-linear activation. Note that non-linear activation is not achieved based on media non-linearity, but instead through interference control. These features in combination with PCSEL devices and systems contribute to significant energy efficiency improvements in various embodiments.

Therefore, controller 150 can modulate linear operation and non-linear activation through phase modulation depending on weight, and can utilize the following formulas for modulation and operation, according to various embodiments:

$$\begin{matrix}{A}_{X} = {A}_{W} = 1 \\ Δ I ( t ) ∝ sin ( {ϕ}_{W} - {ϕ}_{X} ) = {f}_{NL} = {W}_{i j} \sqrt{1 - {X}_{i}^{2}} + {X}_{i} \sqrt{1 - {W}_{i j}^{2}} \\ Where sin ( {ϕ}_{W} ) = {W}_{i j} ; sin ( {ϕ}_{X} ) = {X}_{i}\end{matrix}$$

On the other hand, FIG. 12 shows an example linear function (f_{L}) graph 350 of a correspondence input vector (Xᵢ), for different example weights (Wᵢ), and shown are example weights 360 (−0.9), 362 (−0.5), 364 (−0.1), 366 (0.1), 368 (0.5), and 370 (0.9).

As shown at graph 350 of FIG. 12, the controller 150 can provide linear operation through amplitude modulation, such as utilizing the following formulas:

$$\begin{matrix}{ϕ}_{X} = 0 \\ Δ I ( t ) ∝ {f}_{L} = {A}_{X} {A}_{W} sin ( {ϕ}_{W} ) = {X}_{i} {W}_{i j} \\ Where {A}_{X} = {X}_{i} ; {A}_{W} sin ( {ϕ}_{W} ) = {W}_{i j}\end{matrix}$$

By choosing different weights (Wᵢ), either linear operation or non-linear activation can be enforced on the input vectors X₁ and X₂, with a great flexibility, showing the basis for neural network using PCSELs.

The following formula provides an example function for ΔI(t), a measure of interference between weight and input vectors, and relates to differential current measured at a photodecector (PD) layer 110:

$$Δ I ( t ) = {I}^{+} ( t \} - {I}^{-} ( t ) ∝ {A}_{X} {A}_{W} sin [ {ϕ}_{W} - {ϕ}_{X} ]$$

The following formulas further provide for I+ and I− based on a formula for Ex(t), which represents electric fields emitted by the PCSEL devices described herein. An interfered beam (or spot 264) is dependent on the electrical signal can be formulated as follows:

$$\begin{matrix}{E}_{X} ( t ) = {A}_{X} {e}^{- i ωt + {ϕ}_{X}} , \\ {E}_{X} ( t ) = {A}_{W} {e}^{- i ωt + {ϕ}_{W}} , \\ {I}^{+} ∝ [ {E}_{W} {e}^{- i π / 2} + {E}_{X} ] \times {[ {E}_{W} {e}^{- i π / 2} + {E}_{X} ]}^{*} , \\ {I}^{-} ∝ [ {E}_{W} + {E}_{X} {e}^{- i π / 2} ] \times {[ {E}_{W} + {E}_{X} {e}^{- i π / 2} ]}^{*} , \\ {I}^{+} ∝ {\vert {A}_{X} \vert}^{2} + {\vert {A}_{W} \vert}^{2} + 2 {A}_{X} {A}_{W} sin [ {ϕ}_{W} - {ϕ}_{X} ] , \\ {I}^{-} ∝ {\vert {A}_{X} \vert}^{2} + {\vert {A}_{W} \vert}^{2} - 2 {A}_{X} {A}_{W} sin [ {ϕ}_{W} - {ϕ}_{X} ] ,\end{matrix}$$

The following matrix multiplication can be utilized in various embodiments to determine summed current values Y₁ and Y₂:

$$[ \begin{matrix}Y 1 \\ Y 2\end{matrix} ] = [ \begin{matrix}W 11 & W 12 \\ W 21 & W 22\end{matrix} ] [ \begin{matrix}X 1 \\ X 2\end{matrix} ]$$

With respect to various embodiments described herein, PCSEL ONN operation principles herein can be based upon the teachings of Chen. As such, non-linear weight can directly dictate how much non-linearity is desired, for formulating the weights and also for interference, higher weight means higher non-linearity.

For linear operation:

$$Δ I ( t ) ∝ {A}_{X} ( t ) sin [ {ϕ}_{W} ( t ) ] = {X}_{i} {W}_{ij} ,$$

(amplitude modulation of X)

In embodiments herein, phase modulation provides non-linear activation. As shown in FIG. 12, weights at X₁ and X₂ can directly dictate or influence how much “non-linerarity” is desired. For example, for formulating weights and interference, higher weight will lead to higher non-linerarity.

For non-linear operation:

$$Δ I ( t ) ∝ {I ( t )}^{+} ∝ sin [ {ϕ}_{W} ( t ) - {ϕ}_{X} ( t ) ] = {W}_{ij} \sqrt{1 - {X}_{i}^{2}} - {X}_{i} \sqrt{1 - {W}_{ij}^{2}} ,$$

(amplitude+phase modulation of X)

Thus, PCSELs can be utilized to build and improve upon ONNs as described herein.

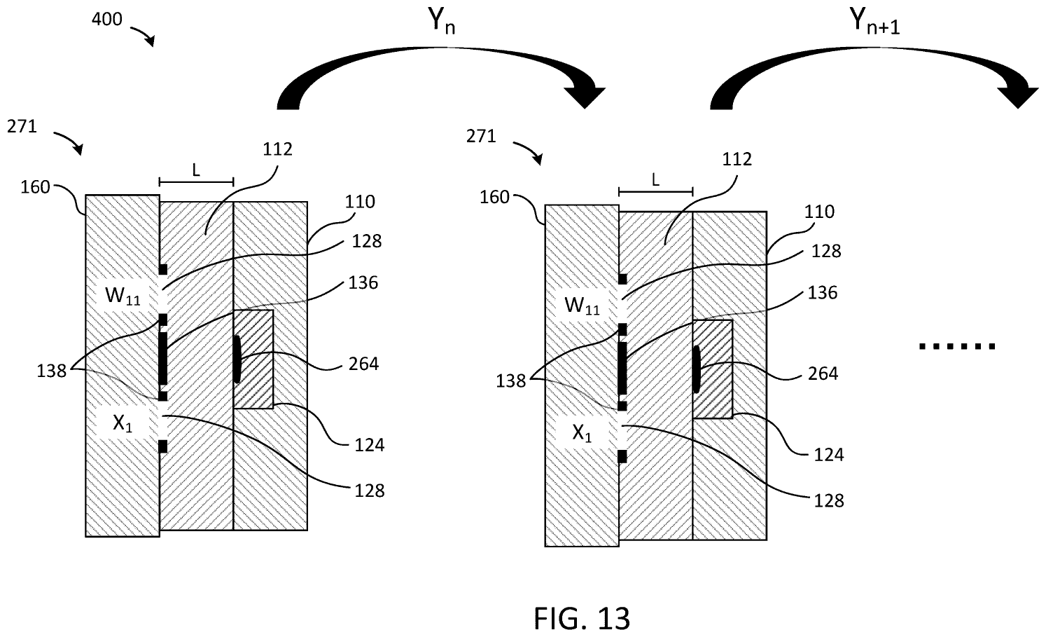

FIG. 13 show a multi-layer PCSEL scheme 400 for ONN, according to various embodiments. Scheme 400 shows multiple PCSEL structures 271 of FIG. 10, above, and shows an example scheme in which a current (Y) can be summed (as shown in FIG. 9) through utilizing multiple PCSELs devices in series to drive a next layer of electronic control for PCSEL operation. As shown a first summed current Yₙ can be fed into a second PCSEL device 271. A further feed of current can follow a formula Yₙ₊₁ with any number of PCSEL devices in series. Such a multi-layer scheme 400 can be used for, e.g., in ONN computing applications. In various embodiments and as shown, multiples of a similar PCSEL device 271 can be utilized. In other embodiments (not shown), one device 271 can be configured to feed output (e.g., current) back to an input control of the same device. Although two PCSELs devices 271 are shown, any number of devices (including 1, 2, 3, etc.) can be utilized.

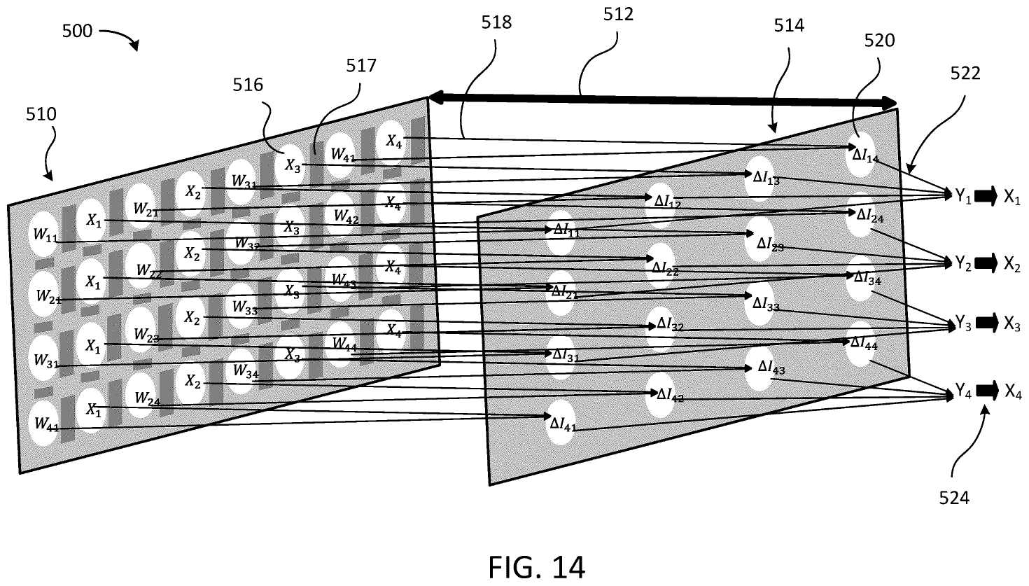

FIG. 14 is another example PCSELs device and PD array system 500 as contemplated herein. As shown, a PCSEL array 510 includes a plurality of PCSEL emitters (e.g., 128) and associated emission components collectively shown at 516 (W₁₁, X₁, etc.). The PCSEL emitters 516 are also shown as operatively coupled by couplers 517, as described above. The PCSELs array 510 drives an output signal or beam 518 through a dielectric layer 512 between the array 510 and a PD array 514 including associated current differential readings 520 shown as ΔI₁₁, etc. The PD array 514 includes a plurality of current summations at 522 to outputs Y₁, Y₂, Y₃, and Y₄, as shown and as described above. The output current summations Y₁, Y₂, Y₃, and Y₄ can then optionally drive the next layer PCSEL array input vector at 524, such as using inputs X₁, X₂, X₃, and X₄, or it can be a final layer.

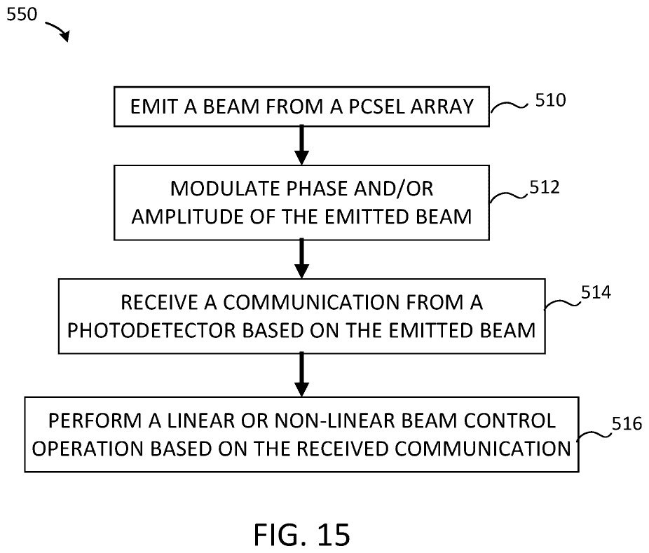

FIG. 15 shows a process 550, according to various embodiments. Process 550 can start with using a controller (e.g., controller 150) to cause a PCSEL array to emit a beam at operation 510. Following operation 510, a phase and/or amplitude of the emitted beam can be modulated by the controller at operation 512. Next, at operation 514, the controller can receive a communication from a photodetector based on the emitted beam. Then, at operation 516, the controller can perform linear or non-linear beam control of the emitted beam at least partially based on the communication received from the photodetector.

FIG. 16 is a block schematic diagram of a computer system 600 according to embodiments of the present disclosure. The computer system 600 can be implemented for performing laser-based computing, such as for optical neural network (ONN) computations, e.g., according to FIGS. 1-15, above.

Computer system 600, as shown, is configured with an interface 616 to enable controller 150 to receive a request to perform laser-based computations using PCSELs, as described with regard to FIGS. 1-15. An input 618 may be received at interface 616. In embodiments, the interface 616 can enable controller 150 to receive, or otherwise access, the input 618 via, for example, a network (e.g., an intranet, or a public network such as the Internet), or a storage medium, such as a disk drive internal or connected to controller 150. The interface can be configured for human input or other input devices, such as described later in regard to components of controller 150. It would be apparent to one of skill in the art that the interface can be any of a variety of interface types or mechanisms suitable for a computer, or a program operating in a computer, to receive or otherwise access or receive a source input or file.

Processors 612, 614 included in controller 150 are connected by a memory interface 620 to memory device or module 630. In embodiments, the memory 630 can be a cache memory, a main memory, a flash memory, or a combination of these or other varieties of electronic devices capable of storing information and, optionally, making the information, or locations storing the information within the memory 630, accessible to a processor. Memory 630 can be formed of a single electronic (or, in some embodiments, other technologies such as optical) module or can be formed of a plurality of memory devices. Memory 630, or a memory device (e.g., an electronic packaging of a portion of a memory), can be, for example, one or more silicon dies or chips, or can be a multi-chip module package. Embodiments can organize a memory as a sequence of bit, octets (bytes), words (e.g., a plurality of contiguous or consecutive bytes), or pages (e.g., a plurality of contiguous or consecutive bytes or words).

In embodiments, computer 600 can include a plurality of memory devices. A memory interface, such as 620, between one or more processors 612/614 and one or more memory devices 630 can be, for example, a memory bus common to one or more processors and one or more memory devices. In some embodiments, a memory interface, such as 620, between a processor (e.g., 612, 614) and a memory 630 can be point to point connection between the processor and the memory, and each processor in the computer 600 can have a point-to-point connection to each of one or more of the memory devices. In other embodiments, a processor (for example, 612) can be connected to a memory (e.g., memory 630) by means of a connection (not shown) to another processor (e.g., 614) connected to the memory 630 (e.g., 620 from processor 614 to memory 630).

Computer 600 can include an input/output (I/O) bridge 650, which can be connected to a memory interface 620, or to processors 612, 614. The I/O bridge 650 can interface the processors 612, 614 and/or memory devices 630 of the computer 600 (or, other I/O devices) to I/O devices 660 connected to the bridge 650. For example, controller 150 includes I/O bridge 650 interfacing memory interface 620 (and/or 622) to I/O devices, such as I/O device 660. In some embodiments, an I/O bridge can connect directly to a processor or a memory, or can be a component included in a processor or a memory. An I/O bridge 650 can be, for example, a peripheral component interconnect express (PCI-Express) or other I/O bus bridge, or can be an I/O adapter.

The I/O bridge 650 can connect to I/O devices 660 by means of an I/O interface, or I/O bus, such as I/O bus 622 of controller 150. For example, I/O bus 622 can be a PCI-Express or other I/O bus. I/O devices 660 can be any of a variety of peripheral I/O devices or I/O adapters connecting to peripheral I/O devices. For example, I/O device 660 can be a graphics card, keyboard or other input device, a hard disk drive (HDD), solid-state drive (SSD) or other storage device, a network interface card (NIC), etc. I/O devices 660 can include an I/O adapter, such as a PCI-Express adapter, that connects components (e.g., processors or memory devices) of the computer 600 to various I/O devices 660 (e.g., disk drives, Ethernet networks, video displays, cameras, keyboards, mice, styli, touchscreens, voice control interfaces, etc.).

Computer 600 can include instructions executable by one or more of the processors 612, 614 (or, processing elements, such as threads of a processor). The instructions can be a component of one or more programs. The programs, or the instructions, can be stored in, and/or utilize, one or more memory devices of computer 600. As illustrated in the example of FIG. 6, controller 150 includes a plurality of programs or modules, such as sensor module 608, PCSEL module 604, amplitude/phase module 606, ONN module 609, differential/summation module 607, and beam module 605. A program can be, for example, an application program, an operating system (OS) or a function of an OS, or a utility or built-in function of the computer 600. A program can be a hypervisor, and the hypervisor can, for example, manage sharing resources of the computer 600 (e.g., a processor or regions of a memory, or access to an I/O device) among a plurality of programs or OSes.

Programs can be “stand-alone” programs that execute on processors and use memory within the computer 600 directly, without requiring another program to control their execution or their use of resources of the computer 600. For example, controller 150 includes (optionally) stand-alone programs in sensor module 608, PCSEL module 604, amplitude/phase module 606, ONN module 609, differential/summation module 607, and beam module 605. A stand-alone program can perform particular functions within the computer 600, such as controlling, or interfacing (e.g., access by other programs) an I/O interface or I/O device. A stand-alone program can, for example, manage the operation, or access to, a memory (e.g., memory 630). A basic I/O subsystem (BIOS), or a computer boot program (e.g., a program that can load and initiate execution of other programs) can be a standalone program.

Controller 150 within computer 600 can include one or more OS 602, and an OS 602 can control the execution of other programs such as, for example, to start or stop a program, or to manage resources of the computer 600 used by a program. For example, controller 150 includes OS 602, which can include, or manage execution of, one or more programs, such as OS 602 including (or, managing) sensor module 608, PCSEL module 604, amplitude/phase module 606, ONN module 609, differential/summation module 607, and/or beam module 605. In some embodiments, an OS 602 can function as a hypervisor.

A program can be embodied as firmware (e.g., BIOS in a desktop computer, or a hypervisor) and the firmware can execute on one or more processors and, optionally, can use memory, included in the computer 600. Firmware can be stored in a memory (e.g., a flash memory) of the computer 600. For example, controller 150 includes firmware 640 stored in memory 630. In other embodiments, firmware can be embodied as instructions (e.g., comprising a computer program product) on a storage medium (e.g., an optical disc, flash memory, or disk drive), and the computer 600 can access the instructions from the storage medium.

In embodiments of the present disclosure, computer 600 can include instructions for using PCSELs in computing applications. Controller 150 includes, for example, sensor module 608, PCSEL module 604, amplitude/phase module 606, ONN module 609, differential/summation module 607, and beam module 605, which can operate to provide computing operation using PCSELs, according to various embodiments herein.

The example computer system 600 and controller 150 are not intended to limiting to embodiments. In embodiments, computer system 600 can include a plurality of processors, interfaces, and inputs and can include other elements or components, such as networks, network routers or gateways, storage systems, server computers, virtual computers or virtual computing and/or I/O devices, cloud-computing environments, and so forth. It would be evident to one of skill in the art to include a variety of computing devices interconnected in a variety of manners in a computer system embodying aspects and features of the disclosure.

In embodiments, controller 150 can be, for example, a computing device having a processor (e.g., 612) capable of executing computing instructions and, optionally, a memory 630 in communication with the processor 612. For example, controller 150 can be a desktop or laptop computer; a tablet computer, mobile computing device, personal digital assistant (PDA), tablet, smartphone, or other mobile device; or, a server computer, a high-performance computer (HPC), or a super computer. Controller 150 can optionally be, for example, a computing device incorporated into a wearable apparatus (e.g., an article of clothing, a wristwatch, or eyeglasses), an appliance (e.g., a refrigerator, or a lighting control), a mechanical device, or, e.g., a motorized vehicle. It would be apparent to one skilled in the art that a computer embodying aspects and features of the disclosure can be any of a variety of computing devices having processors and, optionally, memory devices, and/or programs.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

What is claimed is:

1. A laser-based computing system, comprising:
a two-dimensional photonic crystal surface emitting laser (PCSEL) array comprising a plurality of PCSEL emitters located in a first layer, each emitter oriented in a direction perpendicular to a plane formed by the first layer, wherein the plurality of PCSEL emitters form a preset pattern within the first layer; and
a controller operatively connected to the plurality of PCSEL emitters, the controller configured to modulate phase and/or amplitude of a beam emitted by a PCSEL emitter of the plurality of PCSEL emitters.

2. The system of claim 1, wherein the modulation comprises beam angle, coupling between emitters, and/or intensity.

3. The system of claim 1, further comprising a photodetector array located in a second layer comprised above the first layer, the photodetector array comprising a photodetector operatively connected to the controller, wherein the controller is further configured to:
receive a communication from the photodetector based on a detected signal, and
perform a linear or non-linear beam control operation based at least in part on the communication received at the photodetector.

4. The system of claim 1, wherein the system comprises a PCSEL-based computing architecture.

5. The system of claim 4, wherein the system is configured to create an optical neural network, to perform photonic computation, or to perform neuromorphic computation.

6. The system of claim 1, wherein the system is configured to perform matrix multiplication.

7. The system of claim 1, wherein the PCSEL emitters comprise a laterally-confined lasing mode.

8. The system of claim 1, wherein the controller and PCSEL emitters are configured for coherent injection locking for controlling beam interference.

9. The system of claim 1, wherein the detected signal comprises a summation of differential signals.

10. The system of claim 1, wherein the preset pattern of PCSEL emitters comprises at least one defect or irregularity.

11. A laser-based computing system, comprising:
a two-dimensional photonic crystal surface emitting laser (PCSEL) array comprising a plurality of PCSEL emitters located in a first layer, each emitter oriented in a direction perpendicular to a plane formed by the first layer, wherein the plurality of PCSEL emitters form a preset pattern within the first layer;
a photodetector array located in a second layer comprised above the first layer; and
a controller operatively connected to the plurality of PCSEL emitters and the photodetector array, the controller configured to modulate a plurality of beams emitted by the plurality of PCSEL emitters.

12. The system of claim 11, wherein the modulation of the plurality of beams comprises at least one of:
a) modulation of phase and/or amplitude of the plurality of beams, or
b) modulation of beam angle, coupling between emitters, and/or intensity.

13. The system of claim 11, wherein the photodetector array comprises a photodetector operatively connected to the controller, wherein the controller is further configured to:
receive a communication from the photodetector based on a detected signal, and
perform a linear or non-linear beam control operation based at least in part on the communication received at the photodetector.

14. The system of claim 11, wherein the system comprises a PCSEL-based computing architecture.

15. The system of claim 14, wherein the system is configured to create an optical neural network, to perform photonic computation, or to perform neuromorphic computation.

16. The system of claim 11, wherein the controller utilizes a summation of differential signals received at the photodetector array.

17. A computer program product for performing optical neural network computations, the computer program product comprising a computer-readable storage medium having program code embodied therewith, the program code comprising computer-readable program code configured to cause a processor to perform the steps of:
emitting a beam from a photonic crystal surface emitting laser (PCSEL) array;
modulating phase and/or amplitude of the emitted beam;
receiving a communication from a photodetector based on the emitted beam; and
performing a linear or non-linear beam control operation based at least in part on the communication received from the photodetector.

18. The computer program product of claim 17, wherein the modulation comprises beam angle, coupling between emitters, and/or intensity.

19. The computer program product of claim 17, wherein the optical neural network is configured to perform photonic computation, or to perform neuromorphic computation.

20. The computer program product of claim 17, wherein the communication received from the photodetector comprises a summation of differential signals.
